(19) United States
(12) Patent Application Publication
(10) Pub. No.: US 2008/0037086 A1
(43) Pub. Date: Feb. 14, 2008

(54) Apparatus to control incident angle of reference beam and holographic information recording/reproducing apparatus having the apparatus

(75) Inventors: Taek-seong Jeong, Suwon-si (KR); Jong-chul Choi, Suwon-si (KR); Moon-il Jung, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/655,875

(22) Filed: Jan. 22, 2007

(30) Foreign Application Priority Data
Aug. 11, 2006 (KR) 2006-76370

(51) Int. Cl. G03H 1/28

(52) U.S. Cl. 359/24; 359/25

(57) ABSTRACT

An apparatus to control the incident angle of a reference beam, includes a first lens element to allow the reference beam to be incident on a holographic recording medium, and a driving portion to provide the reference beam to the first lens element and to move in a direction perpendicular to an optical axis to change the incident position of the reference beam on the first lens element in a radial direction of the first lens element, wherein the incident angle of the reference beam incident on the holographic recording medium is determined according to the incident position of the reference beam in a radial direction of the first lens element.

### CROSS-REFERENCE TO RELATED APPLICATION

This application claims all benefits accruing under 35 U.S.C. §119 from Korean Patent Application No. 2006-76370 filed Aug. 11, 2006, in the Korean Intellectual Property Office, the disclosure of which is incorporated herein by reference.

### BACKGROUND OF THE INVENTION

1. Field of the Invention

Aspects of the present invention relate to an apparatus to control the incident angle of a reference beam and a holographic information recording/reproducing apparatus having the above apparatus, and more particularly, to an apparatus to easily control the incident angle of a reference beam, and an apparatus to record/reproduce holographic information having the above apparatus.

2. Description of the Related Art

Holographic technology enables optical signals to be reproduced in its original form and enables a signal in a 3-D image to be reproduced by recording an interference pattern using a signal beam containing a signal and a reference beam without the signal that proceed at different angles from each other. Recently, an optical storage technique to record/reproduce digital data using the operating principle of the above holographic technology has been highlighted. Using the above holographic information recording/reproducing technology, recording/reproducing in units of pages is possible. In other words, recording/reproducing of large amounts of data at once is possible in the form of a 2-D image. Accordingly, a high speed recording/reproducing system can be realized. Also, using a storage method of the holographic technology, information may be stored in a spatially overlapping manner, but can be separately read out using an appropriate multiplexing method. Thus, a very large capacity storage system can be realized.

FIG. 1A shows the operating principle of the holographic technology to record data. Referring to FIG. 1A, a laser beam 1 is divided by a beam splitter 2 into a reference beam 6 and a signal beam 5. The signal beam 5 is modulated into a 2-D signal pattern while passing through a spatial light modulator (SLM) 4, and is incident on a holographic recording medium D. Meanwhile, the reference beam 6 is reflected by a mirror 3 and is incident on the holographic recording medium D in an inclined predetermined angle relative to the holographic recording medium D. When the reference beam 6 and the signal beam 5 are brought together, the reference beam 6 and the signal beam 5 interfere with each other and an interference pattern that is produced by the interference is recorded on the holographic recording medium D.

FIG. 1B shows the operating principle of the holographic technology to reproduce the recorded data. When information is to be reproduced, a laser beam 8 is emitted on to the holographic recording medium D with the same wavelength as the reference beam 6 used to record the information. The beam of the laser 8 must be emitted at the same angle as that of the signal beam used for the recording operation. Accordingly, the 2-D signal pattern containing the original information is reproduced from the holographic recording medium D. The reproduced signal pattern is detected using a detector 9 such as a charge coupled device (CCD).

Although there are many multiplexing methods that may be used for high density recording with a holographic information recording method, an angle multiplexing method is generally used. FIG. 2 is a view for explaining the angle multiplexing method. As shown in FIG. 2, information is stored in the form of a hologram by inputting a first reference beam 6a of a first incident angle θ₁ along with a first signal beam 5. Then, a second signal beam 5′ (coincident to the first signal beam 5) containing other information is input along with a second reference beam 6b of a second incident angle θ₂ to the same position on the holographic recording medium D as that of the first signal-reference beam pair to store the information. When the information is to be reproduced, a first reproducing beam is input at the first incident angle to reproduce the information of the first signal beam while a second reproducing beam is input at the second incident angle to reproduce the information of the second signal beam.

However, in the angle multiplexing method, when the incident angle of the reference beam is changed, it is important to change only the incident angle while maintaining the incident position of the reference beam. For this purpose, in the related art as shown in FIG. 3A, two galvano mirrors 10a and 10b are simultaneously rotated or as shown in FIG. 3B, one galvano mirror 11 is rotated while being moved along an axis. However, in the related art methods as shown in FIGS. 3A and 3B, since the rotation and the translation of the mirrors need to be controlled simultaneously, the two driving portions need to be linked, and it is difficult to accurately control both the rotation and the translation. Accordingly, it is difficult to accurately control the incident angle of the reference beam. Also, according to the related art methods as shown, since the required arrangement causes the size of a control structure of the incident angle of the reference beam to increase, it is difficult to configure a compact holographic storage optical system.

### SUMMARY OF THE INVENTION

To solve the above and/or other problems, aspects of the present invention provide an apparatus to control the incident angle of a reference beam which can only change the incident angle while maintaining the incident position of the reference beam without change, and an apparatus to record/reproduce holographic information having the above apparatus.

Additional aspects and/or advantages of the invention will be set forth in part in the description which follows and, in part, will be obvious from the description, or may be learned by practice of the invention.

According to an aspect of the present invention, there is provided an apparatus to control the incident angle of a reference beam, the apparatus comprising: a first lens element to allow the reference beam to be incident on a holographic recording medium; and a driving portion to provide the reference beam to the first lens element and to selectively move in a direction perpendicular to an optical axis of the first lens element to change the incident position of the reference beam incident on the first lens element in a radial direction of the first lens element, wherein the incident angle of the reference beam incident on the holographic recording medium is determined according to the incident position of the reference beam in the radial direction of the first lens element.

The driving portion may comprise: a spot forming member to form a spot by focusing the reference beam; and a mirror to reflect the reference beam toward the first lens element parallel to the optical axis.

The optical distance between the first lens element and the spot forming member may be about the same as a sum of the focal length of the first lens element and the focal length of the spot forming member.

When the focal length of the first lens element is “f”, a distance between a spot formed by being focused by the spot forming member and the optical axis may be “y”, and the incident angle of the reference beam incident on the holographic recording medium may be θ, an equation expressed as θ=arcsin(y/f) may be satisfied.

The spot forming member may be a lens element having a positive (+) refractive power. The spot forming member may be a pinhole. The spot forming member may be a curved mirror having a concave reflecting surface.

The first lens element may be formed by cutting off portions other than where the reference beam is to be incident.

According to another aspect of the present invention, there is provided an apparatus to record and produce holographic information, the apparatus comprising: a light source to generate a light beam; a beam splitter to divide the light beam generated by the light source into a first light beam and a second light beam; a signal light providing portion to modulate the first light beam into a signal light having a 2-D signal pattern and to provide the modulated signal light beam to a holographic recording medium; and a reference beam incident angle controlling portion to provide the second light beam to the holographic recording medium as a reference beam, wherein the reference beam incident angle controlling portion comprises: a first lens element to provide the reference beam to the holographic recording medium; and a driving portion to provide the reference beam to the first lens element and to selectively move in a direction perpendicular to an optical axis to change the incident position of the reference beam on the first lens element in a radial direction of the first lens element, wherein the incident angle of the reference beam incident on the holographic recording medium is determined according to the incident position of the reference beam in a radial direction of the first lens element.

According to another aspect of the present invention, an apparatus to selectively vary an incident angle of a reference beam while a position of the reference beam is maintained on a holographic recording/reproducing medium, comprises: a first lens element having an optical axis which is substantially perpendicular to a surface of the holographic recording/reproducing medium; and a driving portion to provide the reference beam and to selectively move in a direction substantially perpendicular to the optical axis of the first lens element.

According to another aspect of the present invention, an apparatus to provide a reference beam of a holographic recording and/or reproducing medium comprises: a first optical element fixed relative to the holographic recording and/or reproducing medium; and a second optical element to provide the reference beam to be incident on the first optical element, and which is selectively movable relative to first optical element.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIGS. 1A and 1B are views for explaining the general working principles of a holographic information recording/reproducing apparatus that records and reproduces data using holographic technology;

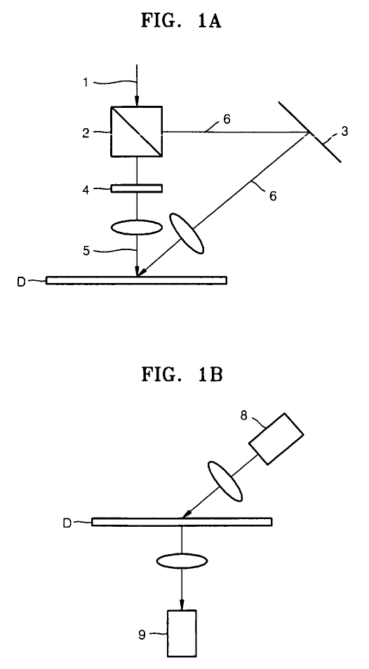

FIG. 2 is a view showing a related art holographic information recording method referred to as an angle multiplexing method;

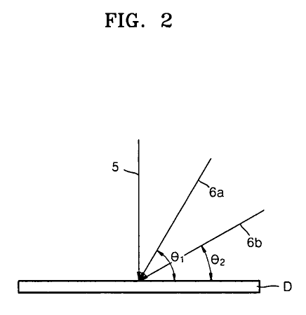

FIGS. 3A and 3B are views showing related art structures to control the incident angle of a reference beam to implement the angle multiplexing method;

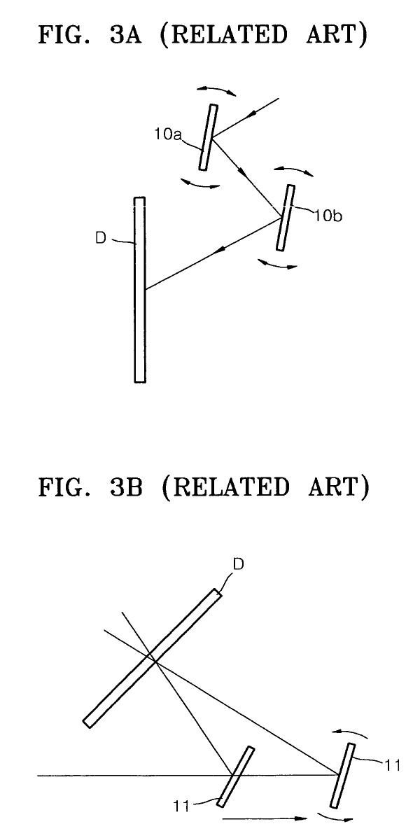

FIG. 4 is a view showing an apparatus to control the incident angle of a reference beam to implement an angle multiplexing method according to an embodiment of the present invention;

FIGS. 5A through 5C are views showing the operation of the apparatus of FIG. 4;

FIGS. 6 through 8 are views showing apparatuses to control the incident angle of a reference beam according to other embodiments of the present invention;

FIG. 9 is a view showing an example of a lens element to provide the reference beam to the holographic recording medium in which the unused part of the lens element is cut off; and

FIG. 10 is a view showing the structure of an apparatus to record/reproduce holographic information according to an embodiment of the present invention having the apparatus of FIG. 4.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

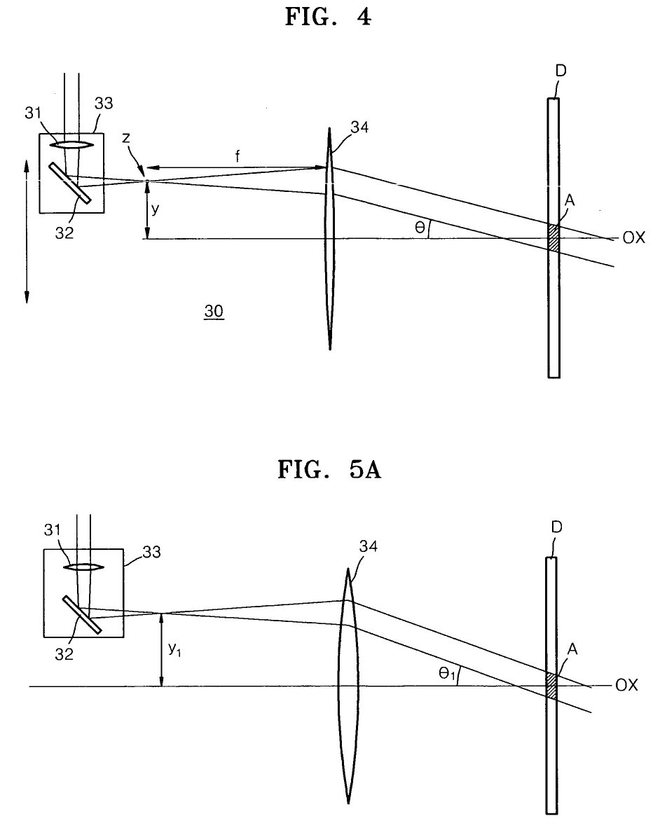

FIG. 4 is a view showing an apparatus 30 to control the incident angle of a reference beam to implement an angle multiplexing method according to an embodiment of the present invention. Referring to FIG. 4, the reference beam incident angle controlling apparatus 30 includes a first lens element 34 to provide a reference beam to a holographic recording medium D at a predetermined angle and a driving portion 33 to provide the reference beam to the first lens element 34. In a non-limiting aspect, the driving portion 33 is moved (or translated) in a direction perpendicular to an optical axis OX, as indicated by an arrow. Accordingly, the incident position of the reference beam changes along the radial direction of the first lens element 34. In this aspect, the first lens element 34 is fixed, although such is not required.

The driving portion 33 includes a second lens element 31 and a mirror 32. The second lens element forms a light spot (or a beam spot) by focusing the reference beam, and the mirror 32 reflects the reference beam in a direction parallel to the optical axis OX towards the first lens element 34. In another embodiment, If there is not a second lens element 31, the reference beam in a parallel beam state is focused by the first lens element 34 to form a spot.

The second lens element 31 causes the reference beam that is refracted by the first lens element 34 to be incident on the holographic recording medium D as a parallel beam. For this purpose, the second lens element 31 may by a lens element having a positive (+) refractive power such as a convex lens. Also, according to the present embodiment, the optical distance between the first lens element 34 and the second lens element 31 is preferably, but not necessarily, about a sum of the focal lengths of the two lens elements 34 and 31. Thus, the spot formed by the second lens element 31 is located in a focal plane of the first lens element 34. In this embodiment, the reference beam that passes through the first lens element 34 and that proceeds toward the holographic recording medium D becomes a parallel beam.

In the above structure, the incident angle θ of the reference beam that is incident on the holographic recording medium D can be determined according to the incident position in the radial direction of the reference beam that is on the first lens element 34. That is, the incident angle θ of the reference beam varies according to how far the position of the spot z formed by the second lens element 31 is separated from the center or the optical axis OX of the first lens element 34. For example, when the focal length of the first lens element 34 is “f” and the distance between the spot formed by the second lens element 31 and the optical axis OX is “y”, the incident angle θ of the reference beam incident on the holographic recording medium D can be expressed by the following equation (1).

θ=arcsin(y/f) [Equation 1]

Thus, the incident angle θ of the reference beam incident on the holographic recording medium D can be changed by positioning the holographic recording medium D at the focal point of the first lens element 34 and moving the driving portion 33 in a direction perpendicular to the optical axis OX, or the radial direction of the first lens element 34 (that is, by changing “y”). For example, assuming that “f” is 10 mm, and “y” is 1 mm, the incident angle of the reference beam is about 5.71°, and when “y” is 0, the incident angle of the reference beam changes to 0°.

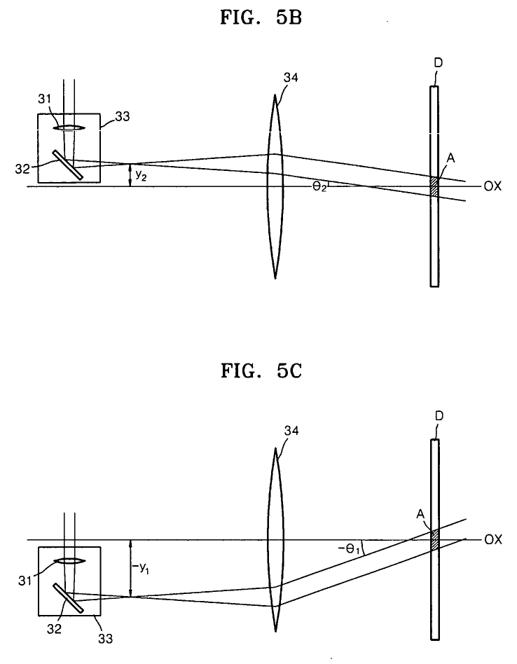

FIGS. 5A through 5C show the operation of the reference beam incident angle controlling apparatus 30 of FIG. 4. As shown in FIGS. 5A through 5C, when the position of the spot z from the optical axis OX changes to y₁, y₂, and −y₁, the incident angle θ of the reference beam changes to θ₁, θ₂, and −θ₁, respectively. Even when the respective incident angle θ of the reference beam is changed, as shown in FIGS. 5A through 5C, the incident position A of the reference beam on the holographic recording medium D can be maintained at a constant position.

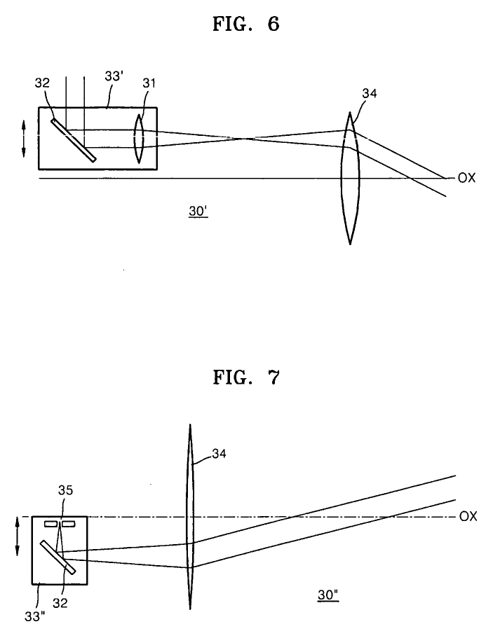

The structure of the driving portion 33 as shown in FIGS. 4 through 5C is an example. Accordingly, various arrangements of the driving portion 33 can be used. For example, FIG. 6 shows a driving portion 33′ of an apparatus 30′ to control the incident angle of a reference beam, where the positions of the second lens 31 and the mirror 32 are changed compared to those of the driving portion 33 of FIG. 4. That is, in FIG. 6, the mirror 32 first reflects the reference beam and then the second lens element 31 focuses the reference beam to form the spot of the reference beam. In this case, the center axis (or the optical axis) of the first lens element 34 and the center axis (or the optical axis) of the second lens element 31 are parallel to each other. The optical distance between the first and second lens elements 34 and 31 is about the same as the sum of the focal lengths of the two lens elements 34 and 31.

FIG. 7 shows an apparatus 30″ to control the incident angle of a reference beam according to another embodiment of the present invention. As shown in FIG. 7, a pinhole 35 is used instead of the second lens element 31. The pinhole 35 is used to cause the reference beam that is refracted by the first lens element 34 to be incident on the holographic recording medium D as a parallel beam. As described above, the role of the second lens element 31 is to form a spot so that the reference beam refracted by the first lens element 34 becomes a parallel beam. Thus, other members to form a spot like the pinhole 35 can be used instead of the second lens element 31. In FIG. 7, the pinhole 35 is arranged to come before the mirror 32 so that the reference beam passing through the pinhole 35 is reflected by the mirror 32. In another example embodiment, the mirror 32 may be arranged to come before the pinhole 35 similar to that shown in FIG. 6. Accordingly, the mirror 32 first reflects the reference beam and the pinhole 35 can form a spot.

FIG. 8 shows an apparatus 30′″ to control the incident angle of a reference beam according to yet another embodiment of the present invention. As shown, the reflection of the reference beam and the formation of the spot are simultaneously performed using a curved mirror 36. That is, the functions of the second lens element 31 or pinhole 35 and the mirror 32 performed by the respective components shown in the other example embodiments are performed by the curved mirror 36. A spherical mirror having a concave surface or a concave aspheric mirror that corrects aberration can be used as non-limiting examples of the curved mirror 36. As described above, as the second lens element 31, the pinhole 35, and the curved mirror 36 all perform the function of forming a spot of the reference beam, theses three elements can be referred to as a spot forming member.

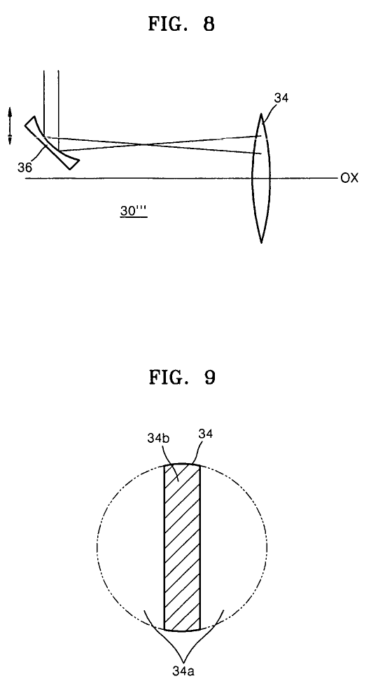

FIG. 9 is a view showing an example of a lens element 34 to provide the reference beam to the holographic recording medium in which the unused part of the lens element 34 is cut off. As shown in FIG. 9, a portion where the reference beam is incident on an incident surface of the first lens element 34 is merely a partial area of the first lens element 34 in the radial direction. That is, as shown in FIG. 9, the reference beam is incident only on a hatched central area 34b, but not on other surrounding areas 34a. Thus, the reference beam is not incident on the surrounding areas 34a and the surrounding area 34 is not used. Accordingly, even when the surrounding area 34a is cut off, the operation of the first lens element 34 is not affected at all. When the surrounding area 34a of the first lens element 34 is cut off, there is material savings and reduction in the overall space and weight of the reference beam incident angle controlling apparatuses 30, 30′, 30″, and 30′″.

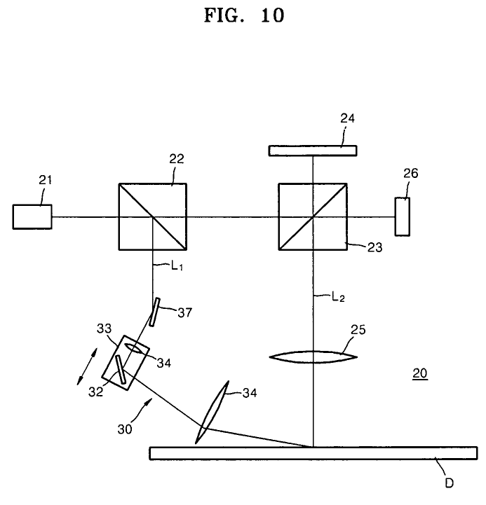

FIG. 10 is a view showing the structure of an apparatus to record/reproduce holographic information according to an embodiment of the present invention having the apparatus of FIG. 4. Referring to FIG. 10, a holographic information recording/reproducing apparatus 20 according to an embodiment of the present invention includes a light source 21 to emit a light beam, a first beam splitter 22 to divide the light beam from the light source 21 into two light beams L₁ and L₂, a signal light providing portion (23, 24, 25) to modulate a part (L₂) of two divided light beams into a signal light having a 2-D signal pattern and to provide the modulated signal light to the holographic recording medium D, a photodetector (26) to detect the signal light reflected by the holographic recording medium D, and the reference beam incident angle controlling apparatus 30 to provide the other part (L₁) of the two divided light beams to the holographic recording medium D as a reference beam.

Although FIG. 10 shows the reference beam incident angle controlling apparatus 30 of FIG. 4 as an example, the other reference beam incident angle controlling apparatuses 30′, 30, and 30′″ shown in FIGS. 6 through 8 can be used instead. Also, the signal light providing portion (23, 24, 25) includes a second beam splitter 23, a spatial light modulator 24, and an objective lens 25. The second beam splitter 23 reflects the light beam passing through the first beam splitter 22 toward the spatial light modulator 24. The spatial light modulator 24 modulates the light beam from the second beam splitter 23 into a signal light having a 2-D signal pattern and reflects the modulated signal light toward the second beam splitter 23. The objective lens 25 focuses the signal light onto the holographic recording medium D.

In the information recording operation of the holographic information recording/reproducing apparatus 20, a part (L₂) of the light beam emitted from the light source 21 passes through the first beam splitter 22 and is used as a signal light while the other part (L₁) of the light beam passes through the first beam splitter 22 and is used as a reference light. The light that passes through the first beam splitter 22 is reflected by the second beam splitter 23 to be incident on the spatial light modulator 24. The spatial light modulator 24 modulates the incident light into a signal light having a 2-D signal pattern and reflects the modulated signal light back to the second beam splitter 23. The modulated signal light passes through the second beam splitter 23 and is incident on the holographic recording medium D via the objective lens 25. In a non-limiting example, the second beam splitter 23 is a polarization beam splitter to reflect the light beam from the first beam splitter 22 and to transmit the light beam from the spatial light modulator 24. However, the structures and positions of the second beam splitter 23, the spatial light modulator 24, and the objective lens 25 to form the signal light may be changed as desired. For example, the spatial light modulator 24 can be positioned between the second beam splitter 23 and the objective lens 25. If so, the spatial light modulator 24 can be a transmission type modulator, instead of a reflection type modulator. Thus, the detailed structure of the signal light providing portion (23, 24, and 25) may have a variety of modifications as desired.

The reference beam incident angle controlling apparatus 30 provides the light beam reflected by the first beam splitter 22 to the holographic recording medium D as the reference beam. As described above, the reference beam incident angle controlling apparatus 30 can control the incident angle of the reference beam to be a desired angle by moving (or translating) the driving portion 33. The reference beam incident angle controlling apparatus 30 can further include an additional mirror 37 to reflect the reference beam from the first beam splitter 22 toward the driving portion 33.

During information reproduction operation by the holographic information recording/reproducing apparatus 20, the reference beam is made incident on the opposite direction of the holographic recording medium D from that of the recording operation. During reproduction, the reference beam must be incident at the same angle as that of the recording operation. Thus, although in FIG. 10, the reference beam incident angle controlling apparatus 30 is shown as being arranged on the same side of the holographic recording medium D as the signal light providing portion, in another example embodiment, the reference beam incident angle controlling apparatus 30 may arranged on the opposite side of the holographic recording medium D as the signal light providing portion. The light beam passing through the holographic recording medium D is reproduced as a signal light having a 2-D pattern signal. The reproduced signal light is reflected by the second beam splitter 23 and detected by the photodetector 26 so that the signal pattern stored on the holographic recording medium D is read out. In a non-limiting example, the photodetector 26 may be a charge coupled device (CCD).

As described above, according to the present invention, when information is recorded/reproduced using the angle multiplexing method of the holographic information recording/reproducing apparatus, the reference beam incident angle controlling apparatus changes only the incident angle without changing the incident position of the reference beam through a very simple structure. Thus, the deterioration of productivity due to a complicated optical structure to control the reference beam can be solved. As a result, a compact holographic information recording/reproducing apparatus can be provided at a lower cost.

In various embodiments, holographic recording/reproducing apparatus refers to a holographic recording and/or reproducing apparatus.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the mirror 32 may be arranged to come before the pinhole 35, and the reference beam incident angle controlling apparatus 30 may arranged on the opposite side of the holographic recording medium D from the signal light providing portion.

Accordingly, it is intended, therefore, that the present invention not be limited to the various example embodiments disclosed, but that the present invention includes all embodiments falling within the scope of the appended claims.

What is claimed is:

1. An apparatus to control an incident angle of a reference beam utilizing a holographic recording and/or reproducing technique, the apparatus comprising:
a first lens element to project the reference beam on to a holographic recording medium; and
a driving portion to provide the reference beam to the first lens element and to selectively move in a direction perpendicular to an optical axis of the first lens element to change an incident position of the reference beam incident on the first lens element in a radial direction of the first lens element,
wherein the incident angle of the reference beam incident on the holographic recording medium is determined according to the incident position of the reference beam in the radial direction of the first lens element.

2. The apparatus of claim 1, wherein the driving portion comprises:
a spot forming member to form a spot by focusing the reference beam; and
a mirror to reflect the reference beam toward the first lens element in parallel to the optical axis.

3. The apparatus of claim 2, wherein the optical distance between the first lens element and the spot forming member is about the same as a sum of the focal length of the first lens element and the focal length of the spot forming member.

4. The apparatus of claim 3, wherein, when the focal length of the first lens element is “f”, a distance between a spot formed by being focused by the spot forming member and the optical axis is “y”, and the incident angle of the reference beam incident on the holographic recording medium is θ, an equation expressed as θ=arcsin(y/f) is satisfied.

5. The apparatus of claim 2, wherein the spot forming member is a lens element having a positive (+) refractive power.

6. The apparatus of claim 2, wherein the spot forming member is a pinhole.

7. The apparatus of claim 1, wherein the driving portion comprises a curved mirror having a concave reflecting surface.

8. The apparatus of claim 1, wherein the first lens element is formed by cutting off portions other than where the reference beam is to be incident.

9. An apparatus to record and/or to produce holographic information, the apparatus comprising:
a light source to generate a light beam;
a beam splitter to divide the light beam generated by the light source into a first light beam and a second light beam;
a signal light providing portion to modulate the first light beam into a signal light having a 2-D signal pattern and to provide the modulated signal light to a holographic recording medium; and
a reference beam incident angle controlling portion to provide the second light beam to the holographic recording medium as a reference beam,
wherein the reference beam incident angle controlling portion comprises:
a first lens element to provide the reference beam to the holographic recording medium, and
a driving portion to provide the reference beam to the first lens element and to selectively move in a direction perpendicular to an optical axis to change an incident position of the reference beam incident on the first lens element in a radial direction of the first lens element,
wherein the incident angle of the reference beam incident on the holographic recording medium is determined according to the incident position of the reference beam in a radial direction of the first lens element.

10. The apparatus of claim 9, wherein the driving portion comprises:
a spot forming member to form a spot by focusing the reference beam; and
a mirror to reflect the reference beam toward the first lens element in parallel to the optical axis.

11. The apparatus of claim 10, wherein the optical distance between the first lens element and the spot forming member is about the same as a sum of the focal length of the first lens element and the focal length of the spot forming member.

12. The apparatus of claim 11, wherein, when the focal length of the first lens element is “f”, a distance between a spot formed by being focused by the spot forming member and the optical axis is “y”, and the incident angle of the reference beam incident on the holographic recording medium is θ, an equation expressed as θ=arcsin(y/f) is satisfied.

13. The apparatus of claim 10, wherein the spot forming member is a lens element having a positive (+) refractive power.

14. The apparatus of claim 10, wherein the spot forming member is a pinhole.

15. The apparatus of claim 9, wherein the driving portion comprises a curved mirror having a concave reflecting surface.

16. The apparatus of claim 9, wherein the first lens element is formed by cutting off portions other than where the reference beam is to be incident.

17. An apparatus to selectively vary an incident angle of a reference beam while a position of the reference beam is maintained on a holographic recording/reproducing medium, comprising:
a first lens element having an optical axis which is substantially perpendicular to a surface of the holographic recording/reproducing medium; and
a driving portion to provide the reference beam and to selectively move in a direction substantially perpendicular to the optical axis of the first lens element.

18. The apparatus of claim 17, wherein the driving portion comprises:
a spot forming member to form a spot by focusing the reference beam; and
a mirror to reflect the reference beam toward the first lens element in parallel to the optical axis.

19. The apparatus of claim 17, wherein when a focal length of the first lens element is “f”, a distance between a spot of the reference beam focused by the spot forming member and the optical axis is “y”, and the incident angle of the reference beam incident on the holographic recording/reproducing medium is θ, an equation expressed as θ=arcsin(y/f) is satisfied.

20. The apparatus of claim 17, wherein the driving portion comprises a curved mirror having a concave reflecting surface.

21. The apparatus of claim 17, wherein the first lens element is formed by cutting off portions other than where the reference beam is to be incident.

22. An apparatus to record and/or to reproduce holographic information, the apparatus comprising:
a light source to generate a light beam;
a beam splitter to divide the light beam generated by the light source into a first light beam and a second light beam;
a signal light providing portion to modulate the first light beam into a signal light having a 2-D signal pattern and to provide the modulated signal light beam to the holographic recording/reproducing medium; and
a reference beam incident angle controlling portion to provide the second light beam to the holographic recording/reproducing medium as the reference beam, wherein the reference beam incident angle controlling portion comprises the apparatus of claim 17.
